(19) United States
(12) Patent Application Publication
(10) Pub. No.: US 2013/0131833 A1
(43) Pub. Date: May 23, 2013

(54) Method, computer program, computer-readable medium and processing unit for controlling field devices

(71) Applicant: VEGA Grieshaber KG, Wolfach (DE)

(72) Inventors: Martin Wettlin, Schiltach (DE); Fridolin Faist, Oberwolfach (DE)

(73) Assignee: VEGA Grieshaber KG, Wolfach (DE)

(21) Appl. No.: 13/676,779

(22) Filed: Nov. 14, 2012

Related U.S. Application Data
(60) Provisional application No. 61/561,009, filed on Nov. 17, 2011.

(30) Foreign Application Priority Data
Nov. 17, 2011 (DE) 11 189 615.5

(51) Int. Cl. G05B 11/01

(52) U.S. Cl. CPC G05B 11/01
USPC 700/9

(57) ABSTRACT

For operating a field device in process automation, automatic cyclic monitoring of a communication interface of an arithmetic unit takes place. If a field device is connected to this communication interface, this is automatically detected. Thereafter, field device operating software is automatically started when the field device can be allocated to the field device operating software. After startup of the operating software, automatic determination of the suitable device driver takes place, which device driver is then uploaded. In this manner, operation of field devices, in particular in complex field device networks, may be greatly facilitated.

### REFERENCE TO RELATED APPLICATIONS

This application claims the benefit of the filing date of EP Patent Application Serial No. EP 11 189 615.5 filed 17 Nov. 2011 and U.S. Provisional Patent Application Ser. No. 61/561,009 filed 17 Nov. 2011, the disclosure of both applications is hereby incorporated by reference.

### TECHNICAL FIELD

The invention relates to process automation. In particular, the invention relates to a method for operating, for starting up and/or for maintaining a field device, to one or several program elements and to a computer-readable medium as well as to an arithmetic unit.

### BACKGROUND INFORMATION

Starting up, maintaining or operating field devices often takes place in a computer-based manner. For example, by way of an interface on the field device, either directly, e.g. by way of a USB port, or indirectly, by way of a communication adapter connected between the field device and the computer, a link is established between the field device and the computer in order to, by way of this link, carry out parameterization and diagnosis of the field device. The computer can be a personal computer, a laptop or some other portable computer. Hereinafter, this computer is also referred to as an “arithmetic unit”.

An operator (user) can start a particular computer program on the arithmetic unit and can select the suitable communication driver from a list of drivers and can set up a so-called “virtual project”. This virtual project simulates the design of the field device network, also known as topology, in other words the interconnection of the individual components of the network.

Further developed products provide the user after startup of the field device operating software with a dialog for selecting a particular type of connection from a list of possible types of connections, in order to trigger automatic searching for connected devices. In relation to the devices found, the “virtual project” is then set up and displayed for the user in a complex project environment. To make it possible for the connected device to be operated by way of the operating software, the device driver then needs to be selected in the virtual project and needs to be opened. Only then does the actual user interface relating to the connected field device appear.

In other words the user needs to reproduce the topology of the field device network on the computer before the field device can be started up.

### SUMMARY OF THE INVENTION

It may be desirable make possible easier operation, starting up and/or maintenance of field devices.

It should be pointed out that the steps described below, for example with reference to the method, can also be implemented in the program elements and in the computer-readable medium and vice versa. These method-related steps can then be carried out by a corresponding arithmetic unit, i.e. processing unit, processor or computer

According to a first aspect of the invention, a method for operating, i.e. for example running, and/or parameterizing a field device in process automation is stated. In particular, the method can also, or as an alternative, be used for starting up and/or for maintaining the field device. According to a further aspect of the invention, the method can, in particular, be designed for operating, for starting up and/or for maintaining one or several field devices that are interconnected, by means of a databus, in the form of a field device network.

Communication between the arithmetic unit and the field device/the field devices can, for example, take place by way of a field bus (HART, Foundation Fieldbus, Profibus, Modbus, etc.) in cases where only one field device is connected to the bus. A connection by way of Ethernet can also be used, in particular in the form of a point-to-point connection. In this case precisely the suitable user interface can automatically be opened. While in the case of field buses with several sensors the system would find these sensors, and subsequently could open the user interface relating to all the devices found, the user would then however still have to decide which of the user interfaces belongs to which device.

Of particular interest in the context of the method described are connections by way of USB, RS232 or wireless connections to an individual device. Normally, private protocols are used for these interfaces. In the case of VEGA this is, for example, the VVO protocol (VEGA Visual Operation).

The field device can, for example, be a fill-level measuring device, for example a fill level radar, an ultrasound device or a measuring device that uses guided microwaves for fill level measuring. Likewise, it can be a pressure measuring device, a limit-level acquisition device, a temperature measuring device or a flow measuring device.

Automatic cyclic monitoring of a communication interface of the arithmetic unit takes place by means of a corresponding program element that is executed on the arithmetic unit. In this process the arithmetic unit automatically detects whether a field device or a communication device of a field device is connected to the communication interface, which field device or communication device can be allocated to field device operating software on the arithmetic unit.

After this the field device operating software is automatically executed when the field device or the communication device can be allocated to the field device operating software on the arithmetic unit. This is followed by automatic determination of a device driver that is suitable for the connected identified field device, which device driver is subsequently automatically uploaded or started for execution on the arithmetic unit.

Accordingly, if the field device is automatically detected at the communication interface of the arithmetic unit as being connected in that location, the suitable device driver is automatically activated so that it can be used by the user in order to start up, maintain or otherwise configure or parameterize the field device.

According to a further aspect of the invention, cyclic monitoring of the communication interface, and detecting whether a field device or a communication device of a field device is connected to the interface takes place, wherein the field device can be associated with a particular field device operating software on the arithmetic unit by a program element that is independent of the field device operating software.

Thus, two separate software components are provided. The first software component is the field device operating software and the second software component, which as a process or service can permanently run in the background, is used for cyclically monitoring the communication interface of the arithmetic unit. As soon as a field device has been detected, the second software component starts the actual operating software and automatically establishes the suitable virtual project with the associated device drivers. In the next step the device driver of the field device is then opened and the device data is automatically loaded into the driver.

According to a further aspect of the invention, the communication interface is a USB interface, a COM port or an Ethernet interface.

According to a further aspect of the invention, the field device operating software is software according to one of the following standards: Field Device Tool (FDT), Electronic Device Description (EDD) or Field Device Integration (FDI).

In the case of FDT the device drivers are referred to as Device Type Managers (DTMs) and in the case of EDD the device drivers are referred to as DDs.

According to a further aspect of the invention, a computer program is stated which comprises one or several program elements that when executed on a processor of an arithmetic unit cause the arithmetic unit to carry out the method-related steps described above and/or below.

According to a further aspect of the invention, a computer-readable medium is stated on which a computer program is stored that comprises one or several program elements, which computer program when executed on a processor of an arithmetic unit causes the arithmetic unit to carry out the method-related steps described above and/or below.

In this arrangement the program elements can be part of software that is stored on a processor of the arithmetic unit. The processor can also form part of the invention. Furthermore, the program elements can be designed in such a manner that they use the invention from the very beginning, or in such a manner that by way of an update they cause an existing program to use the invention.

A further aspect of the invention relates to an arithmetic unit on which a computer program or program elements is/are stored, by means of which the method described above and/or below can be implemented.

Below, exemplary embodiments of the invention are described with reference to the figures.

### BRIEF DESCRIPTION OF THE DRAWINGS

FIG. 1 shows an arithmetic unit that according to one exemplary embodiment of the invention is connected directly to a field device.

FIG. 2 shows an arithmetic unit that according to a further exemplary embodiment of the invention is connected to a field device by way of a communication adapter.

FIG. 3 shows the topology of a project according to the design of FIG. 1.

FIG. 4 shows the topology of a project according to the design of FIG. 2.

FIG. 5 shows a field device network according to a further exemplary embodiment of the invention.

FIG. 6 shows a flow chart of a method according to one exemplary embodiment of the invention.

The illustrations in the figures are diagrammatic and not to scale.

If in the following description of the figures the same reference characters are used in different figures, they describe identical or similar elements.

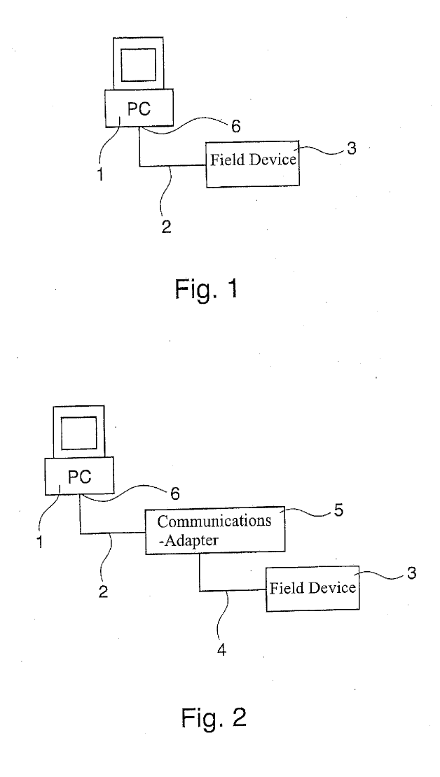

FIG. 1 shows an arithmetic unit 1 in the form of a personal computer, of a laptop or of some other portable computer 1 that by way of the communication interface 6 and a data line 2 connected to it is connected to a field device 3. The field device can be a fill-level measuring device, a pressure measuring device, a flow measuring device, a limit-level acquisition measuring device or a temperature measuring device.

According to the invention it may not be necessary for a user to have extensive knowledge and know-how to set up field device operating software to such an extent that, by way of the projected bus topology (so-called virtual project), access to the field device by way of the respective user interfaces is made possible. This is not necessary for a user to be able to connect to the individual field devices, one after another, and to be able to carry out the desired diagnostics and parameterizations.

Furthermore, according to an exemplary embodiment of the invention it can be provided for after the desired device driver has been opened (which in the present case can take place automatically), the user interface of the actual management software or configuration software does not continue to remain open. In this manner it is possible to reduce the quantity of information on the display so that, in particular, those users that are less well versed can concentrate on the actual task, namely to process precisely that field device for which starting up, parameterization and/or maintenance is to take place.

The concepts of today's user interfaces are associated with various standards (FDT, EDD, FDI, etc.) and in particular in heterogeneous networks with many sensors they provide the specialist with many degrees of freedom. However, in view of the fact that the majority of the installed field devices are used in small installations comprising two to five sensors, it is evident that in these applications the aforesaid operating concepts are unnecessarily complex.

The method according to an exemplary embodiment of the invention uses the advantages of the various already existing operating programs, for example FDT with DTMs, except that confusing elements are left out and introduction to operation is facilitated in that the necessity of project setup (so-called virtual project) can be entirely done without.

The invention relates to a method, program elements, a computer-readable medium and an arithmetic unit for operating field devices such as sensors and actuators in process handling systems as they are typically used these days in industrial environments. These systems comprise, for example, one or several field devices that by way of digitally communicating interfaces are designed for connection to bus systems or for connection to a configuration computer. According to the invention, starting up one or several field devices by way of the operating software can be facilitated.

On the arithmetic unit 1 field device operating software can be executed in order to operate the field device. This field device operating software is, for example, an FDT frame application, FDI hosts or DD hosts. In particular, the FDT frame applications could be used not only for the most common standardized bus systems, but they also make it possible to use devices on the configuration interfaces, when private protocols are communicated by way of the aforesaid.

These systems may share the common feature that they cannot be used on their own. The usability is achieved only in that for the field devices to be operated the associated device drivers are loaded. In the case of FDT these are the so-called DTMs; in the case of the DD hosts the DDs.

In order to make it possible for users to then be able to actually communicate with a field device by way of the user interface on the arithmetic unit, first the actually used topology of the real devices of the field device system or of the field device network needs to be reproduced within the user interface.

FIG. 1 shows one example of an actual topology. In this example the arithmetic unit 1 is connected to the field device 3 by way of a USB interface 2. In the example of FIG. 2 an arithmetic unit 1 is connected to a communication adapter 5 by way of a USB interface 2. The aforesaid in turn is connected, in a cable-bound or wireless manner, to the field device 3 by way of a serial interface 4.

Owing to the fact that detection of the connected device in the field device operating software takes place by way of a topology scan, in other words cyclic monitoring, the functionality is not limited to pure direct connections to a field device. It is, for example, also possible for an interface adapter (as shown in FIG. 2) to be detected at the interface, and consequently the field device operating software determines, by way of the topology scan, that a further device, being a field device, is connected at the communication adapter. In this case the topology scan sets up two device drivers in the appropriate network structure.

If operators wish to make adjustments on the field device 3, they no longer first need to reproduce the virtual project according to the real network by means of the correct device drivers. In particular, it is no longer necessary for users, in the examples of FIGS. 1 and 2, to reproduce different project structures if they want to make adjustments to the field device 3.

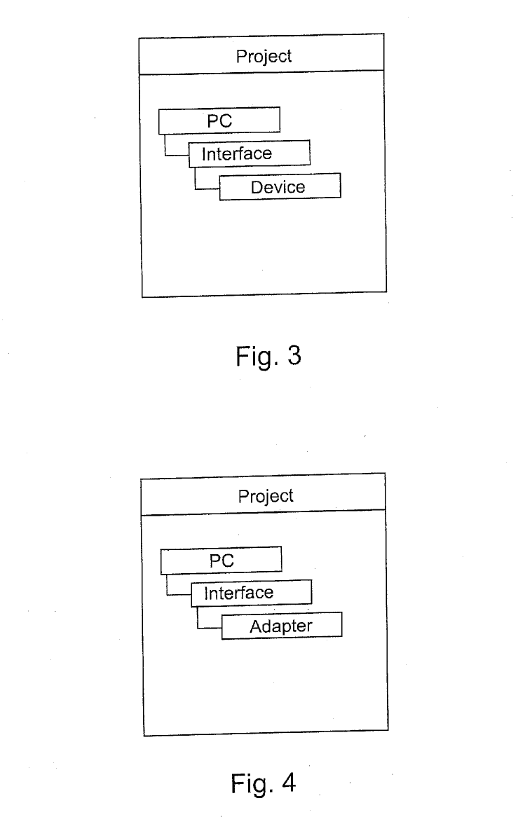

FIG. 3 shows the project according to FIG. 1, and FIG. 4 shows the project according to FIG. 2.

Instead, it is sufficient if the user plugs the USB cable into the USB port of the arithmetic unit. Of course, some other communication interface can be provided for connection to the field device or to the communication adapter, in particular also a wireless interface for radio communication with the field device or with the communication adapter.

This is automatically followed by the start of the suitable device driver of the connected field device, whose user interface then appears on the display of the arithmetic unit so that starting up, maintenance and/or parameterization of the field device can be carried out without delay.

This requirement is met in that for the field device operating software a second software component as a process or service runs permanently in the background. The second software component monitors the interfaces of the arithmetic unit (USB, COM port, Ethernet, etc.) and cyclically checks whether a field device was connected that can be allocated to the corresponding operating software. If a field device has been detected, the second software component starts the actual operating software and automatically sets up the suitable “virtual project” with the associated device driver. In the next step the device driver of the field device is then opened and the field device data is automatically loaded into the driver. After this the user can immediately and without extensive searching commence adjusting the field device.

In a further embodiment of the invention the operating program, which is, for example an FDT frame application, provides an option of being started without its own user interface. While it operates the device drivers and provides the FDT functionality for topology and communication function, it does not, however, provide its own user interface. If the operating program without user interface is combined with the above-mentioned invention, when users have connected the field device to the interface of the computer their display shows nothing but precisely the opened device driver for the connected field device.

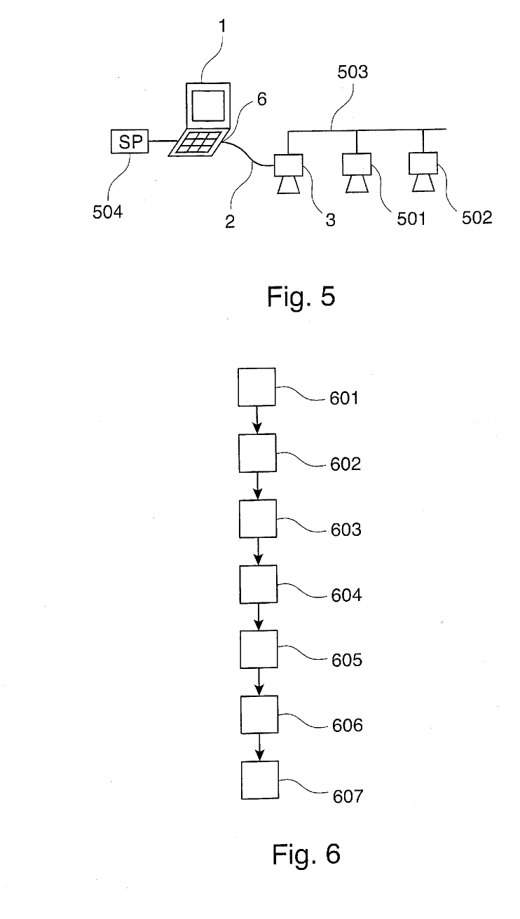

FIG. 5 shows a sensor network according to a further exemplary embodiment of the invention. The arithmetic unit 1 comprises an external storage device 504 that can also be referred to as a computer-readable medium. In this storage device the program elements necessary for implementing the method according to the invention are stored.

By way of an interface cable 2 the arithmetic unit 1 is connected to a field device 3 or directly to the bus 503. Still further field devices 501, 502 are connected to the bus.

Because of cyclic monitoring of the communication interface 6 of the arithmetic unit 1, said arithmetic unit detects that is has been connected to the field device 3 and/or to the bus 503.

Thereafter, within the arithmetic unit it is automatically detected whether the field devices 3, 501, 502 of particular field device operating software running on the arithmetic unit can be opened. The user can now select whether to start the field device operating software of the field device 3, the field device operating software of the field device 501 and/or the field device operating software of the field device 502. Moreover, the field device operating software for each of the three field devices can automatically be started.

At this point the device drivers of those field devices for which the operating software was started are automatically determined. Thereafter the device drivers are automatically loaded and executed on the arithmetic unit. Prior to this it can be provided for a user query as to which device driver is to be loaded and/or executed next to take place.

It should be stated that although FIG. 5 shows three field devices, the method can also be implemented in more complex field device networks with more than three field devices.

FIG. 6 shows a flow chart of a method according to an exemplary embodiment of the invention. In step 601 automatic cyclic monitoring of the communication interface of the arithmetic unit takes place. In step 602 a field device is connected to the communication interface, and in step 603 this is detected by the monitoring software. In step 604 it is then automatically detected that the connected field device can be allocated to field device operating software on the arithmetic unit, and in step 605 this field device operating software is automatically started and executed on the arithmetic unit. Thereafter, in step 606, the appropriate device driver is determined, and in step 607 it is downloaded and executed on the arithmetic unit.

In addition, it should be pointed out that “comprising” does not exclude other elements or steps, and “a” or “an” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

1. A method for operating a field device in process automation, comprising the steps of:
automatic cyclic monitoring of a communication interface of an arithmetic unit;
automatically detecting whether a field device or a communication device of a field device that can be allocated to field device operating software on the arithmetic unit, is connected to the communication interface;
automatically executing the field device operating software when the field device or the communication device of the field device can be allocated to the operating software on the arithmetic unit;
automatically starting a device driver that is suitable for the connected field device;
automatically starting the suitable device driver for execution on the arithmetic unit;
automatically loading field device data into the device driver.

2. The method of claim 1, wherein cyclic monitoring of the communication interface and determining whether a field device is connected to the communication interface, which field device can be allocated to field device operating software on the arithmetic unit, takes place by a program element that is independent of the field device operating software.

3. The method according to claim 1, wherein the field device is a fill-level measuring device, a pressure measuring device, a flow measuring device, a limit-level acquisition device or a temperature measuring device.

4. The method according to claim 1, wherein the communication interface is a USB interface, a COM port or an Ethernet interface.

5. The method according to claim 1, wherein the field device operating software is software according to one of the following standards: Field Device Tool (FDT), Electronic Device Description (EDD) or Field Device Integration (FDI).

6. Program elements which when executed on a processor of an arithmetic unit cause the arithmetic unit to carry out the following steps:
automatic cyclic monitoring of a communication interface of an arithmetic unit;
automatically detecting whether a field device or a communication device of a field device is connected to the communication interface, which field device or communication device can be allocated to field device operating software on the arithmetic unit;
automatically executing the field device operating software when the field device or the communication device can be allocated to the field device operating software on the arithmetic unit;
automatically determining a device driver that is suitable for the connected field device;
automatically starting the suitable device driver for execution on the arithmetic unit;
automatically loading field device data into the device driver.

7. A computer-readable medium on which program elements are stored which when executed on a processor of an arithmetic unit cause the arithmetic unit to carry out the following steps:
automatic cyclic monitoring of a communication interface of an arithmetic unit;
automatically detecting whether a field device or a communication device of a field device is connected to the communication interface, which field device or communication device can be allocated to field device operating software on the arithmetic unit;
automatically executing the field device operating software when the field device or the communication device can be allocated to the field device operating software on the arithmetic unit;
automatically determining a device driver that is suitable for the connected field device;
automatically starting the suitable device driver for execution on the arithmetic unit;
automatically loading field device data into the device driver.

8. An arithmetic unit on which program elements of claim 6 are stored.
